(19) United States
(12) Patent Application Publication
(10) Pub. No.: US 2025/0183635 A1
(43) Pub. Date: Jun. 5, 2025

(54) WIRE HARNESS

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Hideaki ITO, Osaka (JP); Daisuke MIYAWAKI, Osaka (JP); Yuji TAKENAKA, Osaka (JP); Housei MIZUNO, Osaka (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 18/843,502

(22) PCT Filed: Mar. 6, 2023
(86) PCT No.: PCT/JP2023/008233

§ 371 Date: Sep. 3, 2024

(30) Foreign Application Priority Data
Mar. 22, 2022 (JP) 2022-044946

(51) Int. Cl. H02G 3/04; H02G 3/03; H02G 3/16

(52) U.S. Cl. CPC H02G 3/0412; H02G 3/03; H02G 3/16

(57) ABSTRACT

A wire harness includes a circuit including at least a wiring extending from an electric apparatus that includes a heat generating component, a heat conductive plate extending along the wiring, and a heat conductor that thermally connects the circuit and the heat conductive plate.

### TECHNICAL FIELD

The present disclosure relates to a wire harness.

### BACKGROUND ART

Patent Document 1 discloses an interconnection box electrically interconnecting an instrument panel harness, an engine room harness, a door harness, and a floor harness.

### PRIOR ART DOCUMENT

### Patent Document

Patent Document 1: Japanese Patent Application Laid-Open No. 2007-202352

### SUMMARY

### Problem to be Solved by the Invention

By the way, it is desired to enhance heat dissipation of an electric apparatus to which a wire harness is connected.

Therefore, an object of the present disclosure is to improve heat dissipation of an electric apparatus to which a wire harness is connected.

### Means to Solve the Problem

A wire harness of the present disclosure is a wire harness including: a circuit including at least wiring extending from an electric apparatus that includes a heat generating component; a heat conductive plate extending along the wiring; and a heat conductor that thermally connects the circuit and the heat conductive plate.

### Effects of the Invention

According to the present disclosure, it is possible to reduce the size of an electric apparatus to be a connection destination of a wire harness while enhancing heat dissipation.

### BRIEF DESCRIPTION OF DRAWINGS

FIG. 1 is an explanatory diagram illustrating a wiring system including a wire harness in a vehicle.

FIG. 2 is a perspective view illustrating a state where a wire harness according to an embodiment is disposed in a vehicle.

FIG. 3 is a plan view illustrating the wire harness according to the embodiment.

FIG. 4 is an enlarged view of a region A in FIG. 3.

FIG. 5 is a cross-sectional view taken along line V-V in FIG. 4.

FIG. 6 is an exploded plan view of the wire harness.

FIG. 7 is a cross-sectional view illustrating a base member according to a first modification example.

FIG. 8 is a perspective view illustrating a circuit and a heat conductor according to a second modification example.

FIG. 9 is a cross-sectional view taken along line IX-IX in FIG. 8.

FIG. 10 is a diagram explaining a connection relationship between a plurality of types of connectors and a plurality of wirings.

FIG. 11 is a diagram explaining a connection relationship among an apparatus connector, a first harness connector, and a second harness connector.

FIG. 12 is a cross-sectional view illustrating a wiring and a base member according to a third modification example.

FIG. 13 is a diagram illustrating an example of how to divide a plurality of wirings.

FIG. 14 is a diagram illustrating an example of how to divide a plurality of wirings.

FIG. 15 is a perspective view illustrating a wire harness according to a fourth modification example.

FIG. 16 is an exploded perspective view illustrating the wire harness according to the fourth modification example.

FIG. 17 is a plan view illustrating a wire harness according to a fifth modification example.

FIG. 18 is a perspective view illustrating a state where a wire harness according to the fifth modification example is disposed in a vehicle.

### DESCRIPTION OF EMBODIMENTS

### Description of Embodiments of Present Disclosure

Embodiments of the present disclosure are listed and described firstly.

A wire harness of the present disclosure has a configuration described hereinafter.
(1) A wire harness includes a circuit including at least a wiring extending from an electric apparatus that includes a heat generating component, a heat conductive plate extending along the wiring, and a heat conductor that thermally connects the circuit and the heat conductive plate.

According to the present disclosure, since the heat conductor that thermally connects the circuit and the heat conductive plate is provided, the heat generated by the heat generating component is transferred to the heat conductive plate via the circuit and the heat conductor. The heat conductive plate is a plate that extends along the wiring. Therefore, the heat from the heat generating component is effectively dissipated by the heat conductive plate, and the heat dissipation of the electric apparatus to which the wire harness is connected can be enhanced.
(2) In the wire harness of (1), the wiring may include a core wire and a sheath covering the core wire, and the heat conductor may be connected to the core wire. This increases the thermal conductivity between the wiring and the heat conductor.
(3) The wire harness of (2) includes an intermediate peeled portion in which the sheath covering the core wire is partially absent is provided in an intermediate portion along an extending direction of the wiring, and the heat conductor may be connected to the core wire in the intermediate peeled portion. As a result, the sheath can be interposed between the connection position between the core wire and the heat conductor, and the electric apparatus, so that it is easy to ensure necessary insulation.
(4) The wire harness of (2) or (3) further includes a base member interposed between the wiring and the heat conductive plate, in which the heat conductor may connect the core wire and the heat conductive plate via a window part formed in the base member. Accordingly, the wiring can be protected by the base member while ensuring the connection between the core wire and the heat conductive plate by the heat conductor.
(5) In the wire harness of (4), the base member is a protector including a main body having a groove in which the wiring is accommodated, and a lid covering the wiring from a side opposite to the main body, and the window part is formed in a plate portion of one of the main body and the lid, the plate portion being interposed between the wiring and the heat conductive plate, and the other of the main body and the lid presses the wiring toward the heat conductor. As a result, adhesion between the wiring and the heat conductor is enhanced, so that thermal conductivity between the wiring and the heat conductor is enhanced.
(6) In the wire harness of (4), the base member is a sheet member having flexibility. As a result, the base member can be easily provided. In addition, the wiring and the sheet member can be bent together.
(7) In the wire harness of any one of (4) to (6), the base member may keep the plurality of wirings flat. As a result, it is possible to effectively dissipate heat by the heat conductive plate that is easily set widely.
(8) In the wire harness of any one of (1) to (7), the circuit may further include a terminal connected to an end of the wiring, and the heat conductor may connect the terminal and the heat conductive plate. As a result, the heat conductor can be connected to the circuit at a position closer to the electric apparatus.
(9) In the wire harness of (8), the heat conductor includes a heat drawing wire connected to the terminal. As a result, the thermal conductivity via the heat conductor is enhanced.
(10) In the wire harness of (8) or (9), the terminal fits in a cavity of a connector housing, and the heat conductor has an insulating property and includes a filling member filled in the cavity. As a result, the heat conductor to be connected to the terminal can be easily provided.
(11) In the wire harness of any one of (1) to (10), a signal line and a power source line having a conductor cross-sectional area larger than that of the signal line may be provided as the wiring, and the heat conductor may be connected to the circuit of the power source line. Since the power source line has a larger conductor cross-sectional area than that of the signal line, thermal conductivity is also high in many cases. Since the heat conductor is connected to the circuit of the power source line, heat dissipation of the electric apparatus is further enhanced.
(12) In the wire harness of any one of (1) to (11), an apparatus connector connected to a connector of the electric apparatus, and a first harness connector and a second harness connector to each of which a connector of a counterpart wire harness is connected, may be provided, and the wiring may include a plurality of wirings branched from the apparatus connector and connected to the first harness connector and the second harness connector. In this case, the number of connectors connected to the electric apparatus can be reduced. As a result, the number of connectors in the electric apparatus can be reduced, so that the electric apparatus can be downsized.
(13) In the wire harness of (12), the wiring may include a through circuit wiring connecting the first harness connector and the second harness connector. In this case, the plurality of types of counterpart wire harnesses can be connected to each other via the present wire harness, so that the connection between the plurality of types of counterpart wire harnesses and the connection between the plurality of types of counterpart wire harnesses and the apparatus are simplified.

### Detailed Description of Embodiment of Present Disclosure

Specific examples of a wire harness of the present disclosure will be described below with reference to the drawings. The present disclosure is not limited to these examples, but is indicated by claims, and it is intended that meanings equivalent to claims and all modifications within a scope of claims are included.

### Embodiment 1

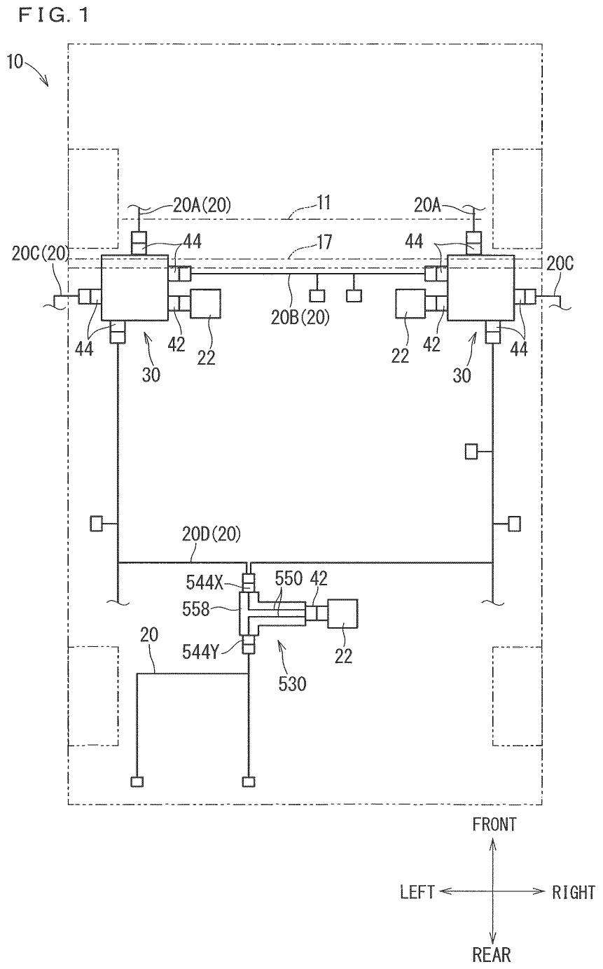

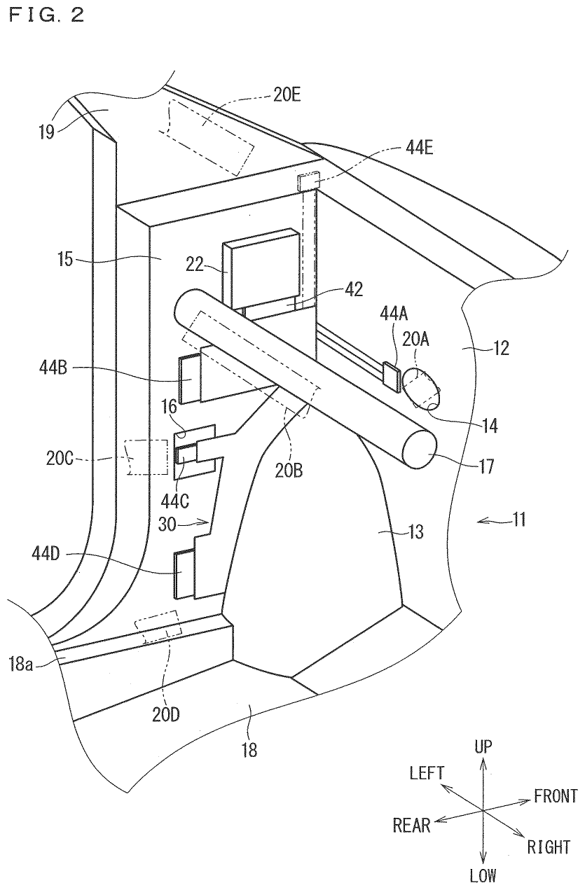

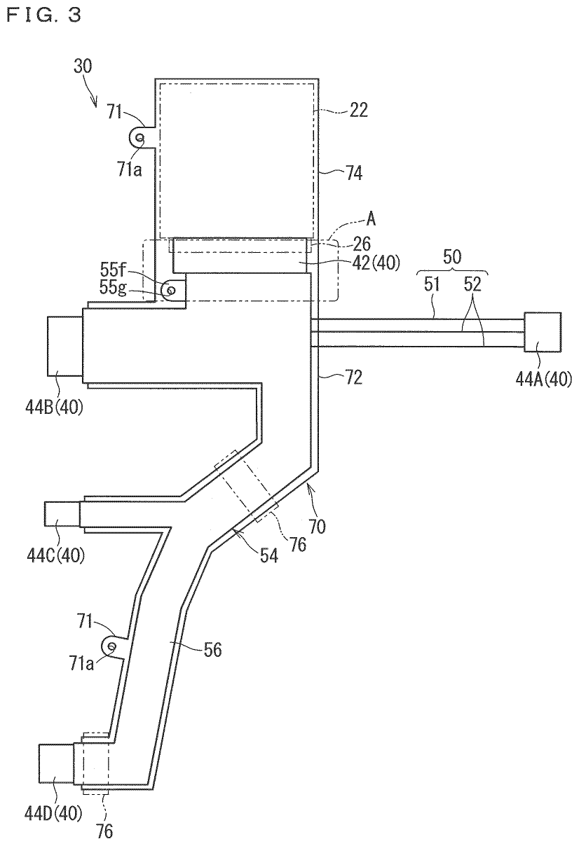

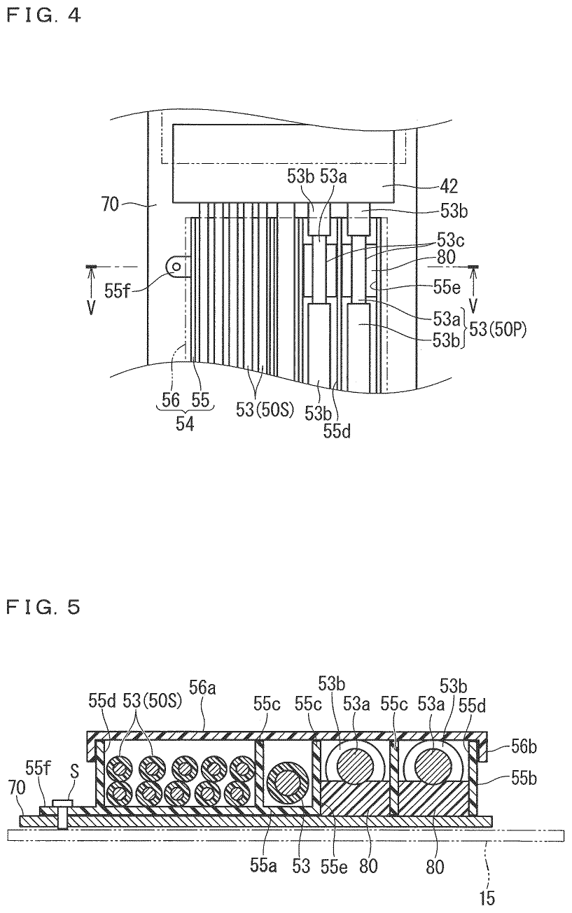

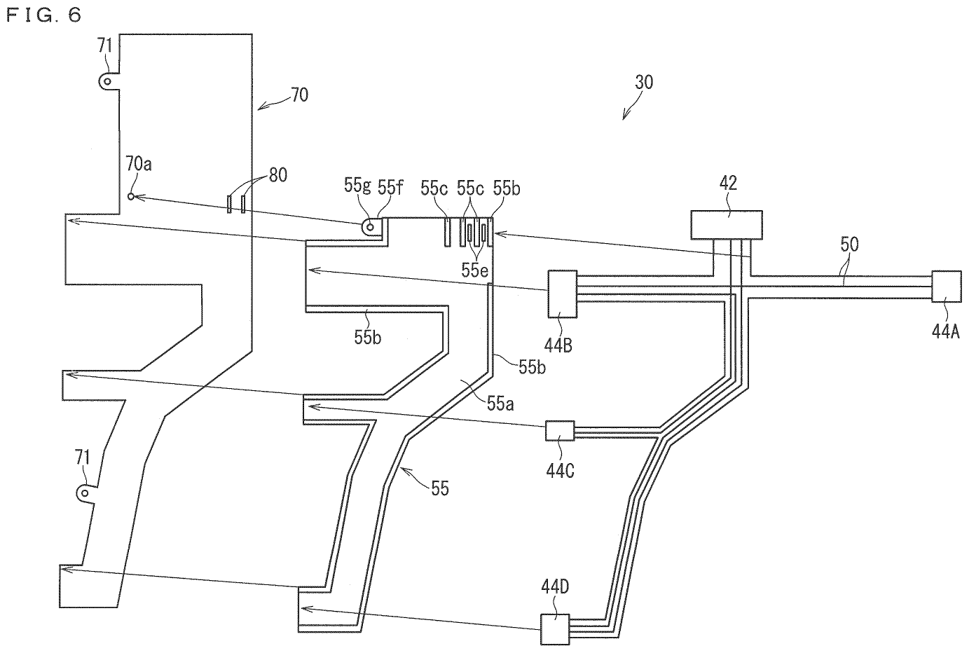

Hereinafter, a wire harness according to an embodiment 1 will be described. FIG. 1 is an explanatory diagram illustrating wiring system including a wire harness 30 in a vehicle 10. FIG. 2 is a perspective view illustrating a state where the wire harness 30 according to the embodiment is disposed in the vehicle 10. A front-rear direction (FRONT, REAR), a left-right direction (LEFT, RIGHT), and an up-down direction (UP, LOW) illustrated in FIG. 2 correspond to a front-back direction, a left-right direction, and an up-down direction in the vehicle 10, respectively. FIG. 3 is a plan view illustrating the wire harness 30 according to the embodiment. FIG. 4 is an enlarged view of a region A in FIG. 3. FIG. 5 is a cross-sectional view taken along line V-V in FIG. 4. FIG. 6 is an exploded plan view of the wire harness 30. Note that in FIG. 4, a lid 56 of a protector 54 is indicated by a two-dot chain line. Further, in FIG. 6, the lid 56 of the protector 54 is omitted.

### <Overall Configuration of Wire Harness

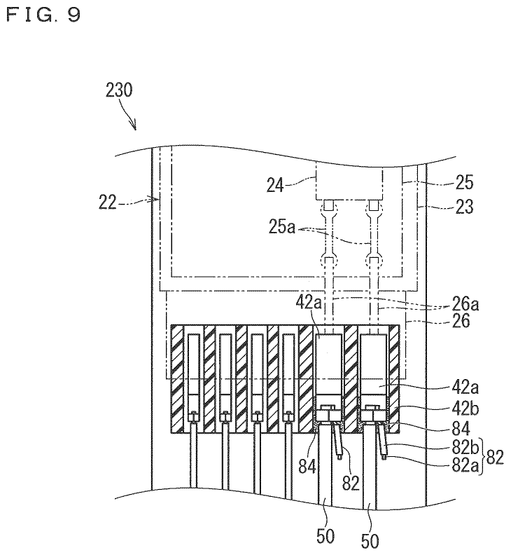

The wire harness 30 is disposed in the vehicle 10, for example. The wire harness 30 is interposed between each of plurality of types of counterpart wire harnesses 20 and an electric apparatus 22 to connect each of the plurality of types of counterpart wire harness 20 and the electric apparatus 22. The plurality of types of counterpart wire harnesses 20 are disposed in areas different from each other in the vehicle 10. The electric apparatus 22 is an apparatus having a heat generating component 24 (see FIG. 9) to be described later. The wire harness of the present embodiment also connects a plurality of types of counterpart wire harnesses 20 to each other. The wire harness 30 includes a circuit, a heat conductive plate 70, and a heat conductor 80.

The circuit of the wire harness 30 includes a circuit for connecting each of the plurality of types of counterpart wire harnesses 20 and the electric apparatus 22. In the present embodiment, the circuit of the wire harness 30 also includes a circuit for connecting the plurality of types of counterpart wire harnesses 20 to each other.

The circuit of the wire harness 30 includes at least a wiring 50. At least a partial path of the circuit of the wire harness 30 is configured of the wiring 50. A plurality of the wirings 50 are arranged along the flat path.

The heat conductive plate 70 is a plate that extends along the wiring 50. In other words, the plurality of wirings 50 include a portion extending along the heat conductive plate 70. The heat conductive plate 70 is arranged along the flat form in which the plurality of wirings 50 extend, and the entire wire harness 30 has a flat form. Since the wire harness 30 has a flat form, the wire harness 30 can be easily disposed along one main surface of the panel.

The heat conductive plate 70 is a plate having good thermal conductivity, for example, a metal plate made of iron, aluminum, copper, or the like. The thermal conductivity of the heat conductive plate 70 is higher than the thermal conductivity of the air, and preferably, higher than the thermal conductivity of resin. For example, the thermal conductivity of the heat conductive plate 70 is 80 (W/mK) or higher, and preferably, 230 (W/mK) or higher.

The heat conductor 80 is interposed between the circuit and heat conductive plate 70 to thermally connect the circuit and heat conductive plate 70. In the present embodiment, the heat conductor 80 is connected to the wiring 50 of the circuit. In the present embodiment, the heat conductor 80 has an insulating property. Accordingly, when both the circuit and a portion of the heat conductive plate 70 with which heat conductor 80 is in contact are conductors, electrical connection between the circuit and the heat conductive plate 70 via the heat conductor 80 is suppressed.

For example, the heat conductor 80 may be a thermally conductive insulating rubber having good thermal conductivity and insulating properties. The thermally conductive rubber is, for example, a rubber containing a filler (magnesium oxide or the like) having good thermal conductivity and insulating properties. The heat conductor 80 may be ceramics or heat conductive grease. The heat conductor 80 is superior in thermal conductivity to the air, and is preferably superior in thermal conductivity to the resin forming a base member 54 and the resin forming a sheath 53b of the wiring 50. For example, the thermal conductivity of the heat conductor 80 is 1.0 (W/mK) or higher, and preferably, 6.5 (W/mK) or higher. The heat conductor 80 may be a conductor (good electrical conductor).

### <Arrangement Area and Connection Relationship of Wire Harness>

An arrangement area of the wire harness 30 in the vehicle 10, the counterpart wire harness 20, and the electric apparatus 22 will be firstly described for the purpose of convenience.

The arrangement area of the wire harness 30 in the vehicle 10 is not particularly limited, but can be appropriately set. When the intervention of the wire harness 30 between the plurality of types of counterpart wire harnesses 20 is considered, the arrangement area of the wire harness 30 is preferably an area close to the boundaries of a plurality of areas where the plurality of types of counterpart wire harnesses 20 are disposed respectively. In the description herein, the arrangement area of the wire harness 30 is an area where a dashboard panel 11 and a cowl side panel 15 intersect with each other.

The dashboard panel 11 partitions an engine room and a vehicle interior in the vehicle 10. An area closer to the front side than the dashboard panel 11 is the engine room, and an area closer to a rear side than the dashboard panel 11 is the vehicle interior. An instrument panel is normally provided closer to the rear side than the dashboard panel 11, and the instrument panel is exposed to the vehicle interior. The dashboard panel 11 includes a body part 12 and a protrusion part 13. A main surface of the body part 12 of the dashboard panel 11 extends in the right-left direction and an up-down direction in the vehicle 10. The protrusion part 13 is provided on a lower side of an end portion of the body part 12 in the right-left direction. The protrusion part 13 a part protruding to a side of the vehicle interior from the body part 12. The protrusion part 13 is a part for providing a wheel house to the vehicle 10.

The cowl side panel 15 is continuously formed with the dashboard panel 11 in each of a left side and a right side of the dashboard panel 11. A main surface of the cowl side panel 15 extends in the front-back direction and the up-down direction in the vehicle 10. FIG. 2 illustrates an area where the cowl side panel 15 provided on the left side of the dashboard panel 11 and the dashboard panel 11 intersect with each other. An edge portion on a lower front side of the cowl side panel 15 is bended in accordance with the protrusion part 13.

An end portion of an instrument panel reinforcement 17 is fixed to the cowl side panel 15. The instrument panel reinforcement 17 is provided between the dashboard panel 11 and the instrument panel. The instrument panel reinforcement 17 is a rod-like member elongated in the right-left direction.

A floor panel 18 is provided on a lower side of the area where the dashboard panel 11 and the cowl side panel 15 intersect with each other. A main surface of the floor panel 18 extends in the front-back direction and the right-left direction in the vehicle 10.

When the arrangement area of the wire harness 30 is the area where the dashboard panel 11 and the cowl side panel 15 intersect with each other, the counterpart wire harnesses 20 are assumed to be an engine room harness 20A, an instrument panel harness 20B, a door harness 20C, a floor harness 20D, and the like. The engine room harness 20A is disposed in an engine room. The instrument panel harness 20B is disposed to extend along the instrument panel reinforcement 17. The door harness 20C is disposed in a door. The floor harness 20D is disposed along a floor. A roof harness 20E may be assumed as the counterpart wire harness 20. The roof harness 20E is disposed in a roof.

In the present disclosure, a term of engine room is an expediential address term of a front room located in front of a vehicle interior, thus an engine needs not necessarily be disposed in the engine room. In the similar manner, in the present disclosure, a term of the engine room harness 20A is an expediential address term of the counterpart wire harness 20 disposed in the front room located in front of the vehicle interior.

The arrangement area of the wire harness 30 and the arrangement area of the engine room harness 20A are partitioned by the dashboard panel 11. Herein, a through hole 14 is formed in the dashboard panel 11. The wire harness 30 and the engine room harness 20A are connected via the through hole 14. In the similar manner, the arrangement area of the wire harness 30 and the arrangement area of the door harness 20C are partitioned by the cowl side panel 15. Herein, a through hole 16 is formed in the cowl side panel 15. The wire harness 30 and the door harness 20C are connected via the through hole 16. A rocker part 18a, for example, is located in a side edge of the floor panel 18 in the vehicle. An end portion of the floor harness 20D connected to the wire harness 30 extends in a front-back direction of the vehicle along the rocker part 18a. The roof is located on an upper side of the area where the dashboard panel 11 and the cowl side panel 15 intersect with each other. For example, an end portion of the roof harness 20E connected to the wire harness 30 extends from the roof to the area where the dashboard panel 11 and the cowl side panel 15 intersect with each other or near the area along an A pillar 19.

### <Electric Apparatus>

The electric apparatus 22 is disposed in the same area as the arrangement area of the wire harness 30. In the example illustrated in FIG. 2, the electric apparatus 22 is fixed to the cowl side panel 15. The electric apparatus 22 may be fixed to the dashboard panel 11, the instrument panel reinforcement 17, the floor panel 18, or the like.

The electric apparatus 22 is an electric apparatus having a heat generating component 24, and is, for example, an electronic control unit (ECU). One central ECU and a plurality of zone ECUs may be provided in the vehicle 10. The zone ECU is provided for each zone sectioned into a plurality of areas in the vehicle 10. The zone ECU mainly controls the apparatus located in the zone. The central ECU achieves control of summing up the plurality of zone ECUs and collaborating in the whole vehicle 10. The electric apparatus 22 may be the zone ECU, for example. In this case, the electric apparatus 22 as the zone ECU controls a plurality of apparatuses as connection destinations of the engine room harness 20A, the instrument panel harness 20B, the door harness 20C, the floor harness 20D, and the like.

Note that the electric apparatus 22 as the ECU may be a general ECU other than the zone ECU. The electric apparatus 22 may not be an ECU, but may be a junction block (also referred to as an electrical junction box), for example. The electric apparatus 22 includes a heat generating component. The heat generating component is an element that generates heat in an electric circuit, such as an electromagnetic relay, a semiconductor switch, a fuse (FUSE), or an integrated circuit (IC).

### <Wire Harness>

In the present embodiment, the wire harness 30 further includes a plurality of types of connectors 42 and 44 and the base member 54, in addition to the circuit including the wiring 50, the heat conductive plate 70, and the heat conductor 80.

The wiring 50 extends from the electric apparatus 22 having the heat generating component 24. In the present embodiment, the wiring is an electrical wire 53. The electrical wire 53 includes a core wire 53a and a sheath 53b covering the core wire 53a. The electrical wire 53 is a single wire in which one core wire 53a is covered with one sheath 53b. The electrical wire may be a composite wire in which one sheath covers a plurality of core wires.

An intermediate peeled portion 53c is provided in an intermediate portion along the extending direction of the electrical wire 53. The intermediate peeled portion 53c is a portion in which the sheath 53b covering the core wire 53a is partially absent. The sheath 53b exists on each of one end side and the other end side of the electrical wire 53 with respect to the intermediate peeled portion 53c. The heat conductor 80 is connected to the intermediate peeled portion 53c of the electrical wire 53.

Here, the heat conductor 80 is connected to some of the wirings 50 among the plurality of wirings 50, and is not connected to some of the other wirings 50. Here, a signal line 50S and a power source line 50P are provided as the wirings 50. The conductor cross-sectional area of the power source line 50P is larger than the conductor cross-sectional area of the signal line 50S. The power source line 50P is configured to allow a larger current to flow than the signal line 50S. The heat conductor 80 is connected to the power source line 50P, and the heat conductor 80 is not connected to the signal line 50S.

The plurality of types of connectors 42 and 44 are connected to connection destinations different from each other. The plurality of types of connectors 42 and 44 are arranged at positions corresponding to connection positions with respect to the electric apparatus 22 and the counterpart wire harness 20 to be connected.

The connectors 42 and 44 are connected to a plurality of end portions of the wirings 50, respectively. The wiring 50 is connected to the electric apparatus 22 via the connector 42, and is connected to the counterpart wire harness 20 via the connector 44. The wiring 50 is not necessarily connected to the electric apparatus 22 and the counterpart wire harness 20 via the connectors 42 and 44. At least a part of the wiring 50 may be a wiring directly drawn out from the electric apparatus 22 or a wiring directly connected to the wiring of the counterpart wire harness 20.

The base member 54 is interposed between the wiring 50 and the heat conductive plate 70. A window part 55e is formed in the base member 54. The heat conductor 80 connects the core wire 53a and the heat conductive plate 70 at the position of the intermediate peeled portion 53c via the window part 55e. For example, the base member 54 may be a member that keeps the plurality of wirings 50 flat. Moreover, the base member 54 may be a member that protects the plurality of wirings 50. The base member 54 may be formed in a shape that branches or bends according to the positions of the plurality of types of connectors 42 and 44 and the path of the wiring 50.

In the present embodiment, the base member 54 is a protector 54. The protector 54 includes a main body 55 and a lid 56. A groove 55d is formed in the main body 55. The wiring 50 is accommodated in the groove 55d. The lid 56 covers the opening of the groove 55d. The protector 54 is a molded article made of a resin having relatively high rigidity, and does not have flexibility to bend together with the wiring 50. The protector 54 is molded in advance so as to have a shape corresponding to the path of the wiring 50, and has rigidity capable of maintaining the shape. By being accommodated in the protector 54, the wiring 50 is held in a state corresponding to the shape of the protector 54, that is, in a state along a predetermined path of the wiring 50.

The main body 55 includes a bottom plate 55a and a plurality of side plates 55b. The plurality of side plates 55b protrude on the main surface of the bottom plate 55a. The main body 55 has rigidity capable of maintaining a state in which the side plates 55b protrude from the bottom plate 55a. The plurality of side plates 55b are arranged at intervals in the width direction of the bottom plate 55a. The side plates 55b are provided at both ends along the width direction of the bottom plate 55a. The side plates 55b partition the inside and the outside of the main body 55. A protruding dimension of the side plate 55b from the bottom plate 55a is smaller than a width dimension of the bottom plate 55a. Therefore, in the main body 55, the accommodation space for accommodating the plurality of wirings 50 is made flat. By providing the side plates 55b along the predetermined path, a flat accommodation space for accommodating the plurality of wirings 50 is formed in the protector 54 along the predetermined path. Since the plurality of wirings 50 are accommodated in the flat accommodation space, the wire harness 30 is maintained in a flat form. It is not essential that the wire harness 30 be flat. The protector may be formed to have substantially the same width dimension and height dimension.

At the end portion on the apparatus connector 42 side, a plate portion is also provided at an intermediate portion along the width direction of the bottom plate 55a. The plate portion at the intermediate portion along the width direction of the bottom plate 55a is a partition plate 55c. The partition plate 55c partitions the internal space of the main body 55. With the partition plate 55c being provided, the plurality of grooves 55d are provided in parallel in the internal space of the main body 55.

The partition plate 55c is partially provided at an end portion on the apparatus connector 42 side. A configuration in which a plurality of parallel accommodation spaces are formed in a portion where the partition plate 55c is provided and a configuration in which one accommodation space is formed in a portion where the partition plate 55c is not provided are combined. One of the configuration in which a plurality of parallel accommodation spaces are formed in a portion where the partition plate 55c is provided and the configuration in which one accommodation space is formed in a portion where the partition plate 55c is not provided may be omitted, and the other may be continuous.

Here, three partition plates 55c are provided in parallel at the end portion on the apparatus connector 42 side. Accordingly, at the end portion on the apparatus connector 42 side, four grooves 55d are provided in parallel in the internal space of the main body 55. In each of the three grooves 55d among the four grooves 55d, one wiring 50 is accommodated. The wiring 50 is a power source line 50P or a ground line. In one groove 55d among the four grooves 55d, a plurality of wirings 50 are collectively accommodated. Those wirings 50 are signal lines 50S.

The lid 56 includes a lid plate portion 56a and a side plate portion 56b. The lid plate portion 56a covers the opening of the groove 55d. The side plate portion 56b overlaps the outside of the side plate 55b. The side plate portion 56b may be omitted. The lid 56 is attached to the main body 55. For example, the main body 55 and the lid 56 may be locked by locking a locking portion provided on the lid 56 to a receiving portion provided on the main body 55.

The connectors 42 and 44 may be held by the protector 54. The wiring 50 may extend from the end of the protector 54, and the connectors 42 and 44 may be provided apart from the protector 54.

In the present embodiment, the heat conductive plate 70 has a flat plate shape. The heat conductive plate 70 may be bent in the thickness direction. The heat conductive plate 70 includes a wiring overlapping region 72. The wiring overlapping region 72 is a region extending along the wiring 50. In the present embodiment, the wiring overlapping region 72 extends along the entire path of the wiring 50 except for a region adjacent to the connector 44 at the end of the wiring 50. The wiring overlapping region 72 may overlap at least a part of the path of the wiring 50. The wiring overlapping region 72 may have an additional region that does not overlap the path of the wiring 50.

The heat conductive plate 70 may have a fixing portion for fixing to the vehicle by a fixing tool such as a bolt or a clip. FIG. 3 illustrates a part of a fixing piece 71 as an example of the fixing portion. The fixing piece 71 is a partial plate-like portion extending outward from an outer peripheral edge of the heat conductive plate 70, and has an insertion hole 71a. In a state where the fixing piece 71 is in contact with the vehicle (for example, the cowl side panel 15), the fixing piece 71 is fixed to the vehicle with a bolt or the like. When the heat conductive plate 70 is in contact with the vehicle, heat is easily transferred from the heat conductive plate 70 to the vehicle. A plurality of fixing pieces 71 are provided around the heat conductive plate 70 as necessary.

The fixing structure of heat conductive plate 70 to the vehicle is not limited to the above example. The heat conductive plate 70 may be fixed to the vehicle by another fitting structure, welding, or the like, or may be supported at a fixed position by the electric apparatus 22 or the like.

The protector 54 may be integrated with the heat conductive plate 70. For example, the protector 54 may have a fixing portion for fixing to the heat conductive plate 70 with a fixing tool such as a bolt or a clip. FIG. 3 illustrates a part of a fixing piece 55f as an example of the fixing portion. The fixing piece 55f is a partial plate-like portion extending outward from the outer peripheral edge of the main body 55 or the lid 56, and has a hole 55g. The fixing piece is fixed to the heat conductive plate 70 by a bolt S or the like in a state where the fixing piece 55f is in contact with heat conductive plate 70. A plurality of the fixing pieces 55f are provided around the protector 54 as necessary.

In addition, for example, in a state where the wiring 50 and the protector 54 are disposed on one main surface (the side opposite to the side in contact with the vehicle) of the heat conductive plate 70, the binding member 76 (see FIG. 3) such as an adhesive tape or a binding band may be bound thereto. The integration of the wiring 50 and the protector 54 with the heat conductive plate 70 is not limited to the above example, and may be performed by, for example, a double-sided tape, an adhesive, or the like.

When wiring 50 and heat conductive plate 70 are integrated, the heat conductive plate 70 can play a role of keeping the wiring 50 flat along the heat conductive plate 70.

In the present embodiment, the heat conductive plate 70 includes an apparatus overlapping region 74. The apparatus overlapping region 74 is a region overlapping the electric apparatus 22. In the present embodiment, the connector 42 is connected to the electric apparatus 22. Therefore, the electric apparatus 22 is located on the extension of the connector 42 in the wiring 50. The apparatus overlapping region 74 is a region extending from the wiring overlapping region 72 toward a region where the electric apparatus 22 is located. In the present embodiment, the apparatus overlapping region 74 overlaps the entire electric apparatus 22. The apparatus overlapping region 74 may overlap at least a part of electric apparatus 22. Further, the apparatus overlapping region 74 may have an additional region that does not overlap the electric apparatus 22.

The plurality of wirings 50 may be fixed to the heat conductive plate 70 by a binding member such as an adhesive tape or a binding band, a double-sided tape, an adhesive, or the like.

### <Heat Dissipation Path Using Heat Conductive Plate in Wire Harness>

A heat dissipation path using the heat conductive plate 70 in the wire harness 30 will be described.

A window part 55e is formed in a plate portion of the base member 54 facing the wiring 50 in which heat is desired to be dissipated. The window part 55e may be formed at a position where at least a part of the wiring 50 faces outward. That is, when the plate portion of the base member 54 where the window part 55e is formed is observed from the outside along the direction perpendicular to the plate portion, at least a part of the window part 55e and at least a part of the wiring 50 may overlap each other. In FIGS. 5 and 6, the window part 55e is individually provided for each of the plurality of wirings 50 in which heat is desired to be dissipated. The window part may connect a plurality of regions overlapping the plurality of wirings 50 in which heat is desired to be dissipated and the plurality of regions. That is, the window part may be formed as one window part common to the plurality of wirings 50 in which heat is desired to be dissipated.

The window part 55e is formed in a plate portion interposed between the wiring 50 and the heat conductive plate 70, of the bottom plate 55a and the lid plate portion 56a. Here, the protector 54 is disposed such that the bottom plate 55a is interposed between the wiring 50 and the heat conductive plate 70. Therefore, the window part 55e is formed in the bottom plate 55a. The protector 54 may be disposed such that the lid plate portion 56a is interposed between the wiring 50 and the heat conductive plate 70. In this case, the window part may be formed in the lid plate portion 56a.

The window part 55e is provided slightly inside the end edge portion of the bottom plate 55a on the apparatus connector 42 side. The intermediate peeled portion 53c is provided at a position corresponding to the window part 55e. Here, the intermediate peeled portion 53c is longer than the window part 55e along the extending direction of the wiring 50. The dimension of the window part 55e along the width direction of the wiring 50 is larger than the diameter of the core wire 53a.

The wiring overlapping region 72 of the heat conductive plate 70 is disposed along the plate portion of the base member 54 where the window part 55e is formed. Preferably, the heat conductive plate 70 is kept at a fixed position with respect to the base member 54. The base member 54 may be fixed to the heat conductive plate 70. For example, the hole 55g of the fixing piece 55f may be made to overlap the hole 70a formed in the heat conductive plate 70. In this case, the bolt S may be inserted into the hole and fastened to the nut. When the nut is provided on the vehicle side, the protector and the heat conductive plate 70 can be collectively fixed to the vehicle 10. FIG. 6 illustrates one fixing piece. A plurality of fixing pieces are provided around the base member as necessary. It is also possible to separately fix the heat conductive plate 70 and the base member to the vehicle 10 or the like, to thereby keep the heat conductive plate 70 and the base member in a constant positional relationship.

The heat conductor 80 is formed in a shape that can be disposed in the window part 55e. In the present embodiment, the window part 55e has a rectangular shape, and the heat conductor 80 has a rectangular parallelepiped shape that can be disposed in the window part 55e. A surface of the heat conductor 80 on the wiring 50 side can face the wiring 50. The surface of the heat conductor 80 may face at least a part of the wiring 50. The surface of the heat conductor 80 may have a portion protruding laterally from the wiring 50. In the present embodiment, the surface of the heat conductor 80 spreads to the same size as the window part 55e. The surface of the heat conductor 80 before coming into contact with the wiring 50 is a flat surface, and may be deformed into a concave surface corresponding to the convex surface of the outer surface of the wiring 50 by being pressed toward the wiring 50.

The heat conductor 80 may have another shape other than a rectangular parallelepiped. For example, the heat conductor 80 may have a columnar shape, and a circular end surface may be disposed to face the wiring 50.

The outer peripheral surface of the heat conductor 80 is preferably disposed so as to be in contact with the inner peripheral surface of the window part 55e. As a result, water, dust, and the like hardly enter the base member 54 through between the heat conductor 80 and the window part 55e.

When the heat conductor 80 is made of rubber, the heat conductor 80 is easily brought into close contact with the wiring 50 and the heat conductive plate 70. In addition, it is easy to bring the heat conductor 80 into close contact with the inner peripheral surface of the window part 55e.

The lid 56 may press the wiring 50 toward the heat conductor 80. The wiring 50 and the heat conductor 80 may be pressed by the peripheral edge portion of the window part 55e of the bottom plate 55a and by the lid 56. Here, the heat conductor 80 protrudes into the internal space of the protector 54 through the window part 55e and pushes the core wire 53a in the intermediate peeled portion 53c to the lid 56 side. As a result, a portion of the wiring 50 disposed at the window part 55e and an adjacent part thereto separates from the bottom plate 55a toward the lid plate portion 56a. When the lid plate portion 56a presses this portion, the core wire 53a of the intermediate peeled portion 53c is pressed against the heat conductor 80. The lid 56 may be provided with a pressing member protruding from the inner surface of the lid plate portion 56a toward the wiring 50. The pressing member and the heat conductor 80 may sandwich the wiring 50 so as to press the wiring 50 from opposite sides.

The heat conductor 80 may not protrude into the internal space of the protector 54 through the window part 55e. In this case, a pressing member provided to the lid 56 may press the wiring 50 against the heat conductor 80. A part of the wiring 50 pressed by the pressing member may enter the window part 55e.

Another inclusion may be interposed between the heat conductor 80 and the wiring 50 or between the heat conductor 80 and the wiring overlapping region 72. The inclusion is a heat conductive sheet, a heat conductive adhesive, a heat conductive double-sided tape, or a heat conductive grease that enhances adhesion to the counterpart side. When the inclusion is a heat conductive adhesive or a heat conductive double-sided tape, the heat conductor 80 can be kept fixed to the wiring 50 or the wiring overlapping region 72.

The heat conductor 80 may be fixed to the heat conductive plate 70. When the heat conductor 80 is fixed to the heat conductive plate 70, the heat conductor 80 can be easily interposed between the wiring 50 and the wiring overlapping region 72 during the work of integrating the protector 54 and the heat conductive plate 70. For example, when the protector 54 is assembled to the heat conductive plate 70, if the heat conductor 80 fixed to the heat conductive plate 70 is inserted into the window part 55e, the heat conductor 80 is disposed between the wiring 50 and the wiring overlapping region 72.

The heat conductor 80 may be fixed to the protector 54. When the heat conductor 80 is fixed to the protector 54, the heat conductor 80 can be easily interposed between the wiring 50 and the wiring overlapping region 72 via the window part 55e during the work of integrating the protector 54 and the heat conductive plate 70. For example, a groove to be fitted to the peripheral edge of the window part 55e may be formed on the outer periphery of the heat conductor 80. Further, for example, the heat conductor 80 may have a main body portion having a size corresponding to the window part 55e, and a flange portion that expands outside the main body portion and is larger than the window part 55e. The main body portion may protrude toward the outside of the protector 54 through the window part 55e, and the flange portion may be caught on the peripheral edge portion of the window part 55e inside the protector 54.

The heat conductor 80 may be fixed to the wiring 50. When the heat conductor 80 is fixed to the wiring 50, positioning of the heat conductor 80 with respect to the window part 55e is not necessary during the work of integrating the protector 54 and the heat conductive plate 70, and the heat conductor 80 can be easily interposed between the wiring 50 and the wiring overlapping region 72. For example, the heat conductor 80 may have a wiring fixing portion fixed to wiring 50 and a protruding portion protruding from the wiring fixing portion. The protruding portion may protrude to the outside of the protector 54 through the window part 55e.

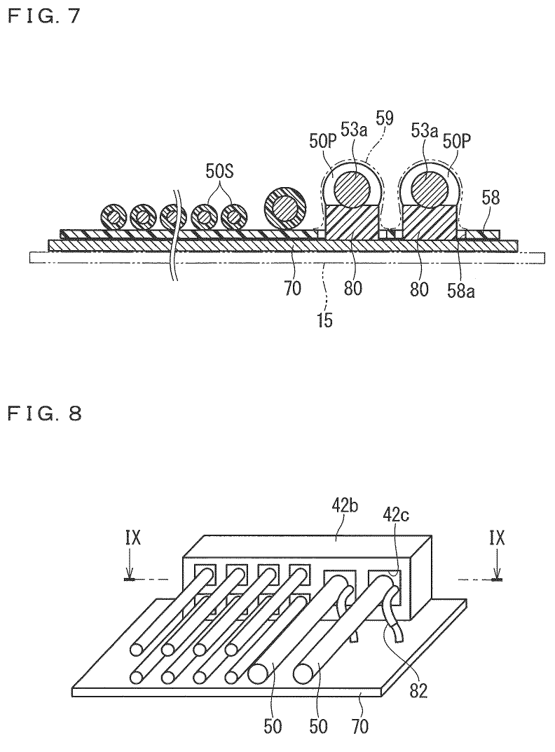

FIG. 7 illustrates a first modification example of the base member 54. As illustrated in the drawing, a base member 362 according to the modification example is a sheet member 58 having flexibility. The sheet member 58 has flexibility capable of following the bending of the wiring 50. Thus, the base member 362 can be easily provided. In addition, the wiring 50 and the sheet member 58 can be bent together. The sheet member 58 covers the wiring 50 from one side. In this case, as illustrated in FIG. 7, on the side where the sheet member 58 is not provided, an insulating member 59 such as an insulating tape different from the sheet member 58 may cover the core wire 53a of the intermediate peeled portion 53c. This suppresses exposure of the core wire 53a.

The sheet member 58 is, for example, a resin sheet. The sheet member 58 may be a sheet having a fiber material such as a nonwoven fabric. The sheet member 58 may be a sheet having a solid cross section.

The wiring 50 may be fixed to the sheet member 58. A fixing mode between the wiring 50 and the sheet member 58 is not particularly limited, and can be appropriately set. For example, the wiring 50 and the sheet member 58 may be fixed by fusion. In this case, the resin contained in at least one of the sheath 53b of the electrical wire 53 as the wiring 50 and the main surface of the sheet member 58 is melted and bonded and fixed to the surface of the counterpart member. Furthermore, for example, the wiring 50 and the sheet member 58 may be attached by an adhesive material or a gluing material. The plurality of wirings 50 are arranged side by side on the main surface of the sheet member 58. The parallel state may be maintained by fixing each wiring 50 to the sheet member 58.

The window part 58a is formed in the sheet member 58. As in the case where the base member is the protector 54, the core wire 53a in the intermediate peeled portion 53c and the heat conductor 80 are connected via the window part 58a. The wiring 50 may be fixed to the sheet member 58 at positions on both adjacent sides of the intermediate peeled portion 53c. As a result, when the heat conductor 80 protrudes to the wiring 50 side from the surface of the sheet member 58 on which the wiring 50 is disposed via the window part 58a and comes into contact with the wiring 50, the wiring 50 is less likely to separate from the heat conductor 80.

A second modification example of the circuit and the heat conductor 80 is illustrated in FIGS. 8 and 9.

The circuit further includes a terminal 42a connected to an end of the wiring 50. the heat conductor 82 connects the terminal 42a and the heat conductive plate 70. As a result, the heat conductor 80 can be connected to the circuit at a position closer to the electric apparatus 22. The terminal 42a is a connector terminal provided to the apparatus connector 42. The terminal 42a is held by a connector housing 42b of the apparatus connector 42. Here, the terminal 42a is accommodated in a cavity 42c of the connector housing 42b.

The electric apparatus 22 illustrated in FIG. 9 includes a case 23, the heat generating component 24, a circuit board 25, and a connector 26.

The case 23 is a box made of resin or the like. For example, the case 23 is formed in a flat box shape. The heat generating component 24 is accommodated in the case 23. The circuit board 25 is fixed in the case 23. The heat generating component 24 is mounted on the circuit board 25. The circuit board 25 has a circuit pattern 25a formed of copper foil or the like. In FIG. 9, one heat generating component 24 and the circuit pattern 25a on which the heat generating component 24 is mounted are illustrated as representatives. The number and position of the heat generating components 24 are arbitrary. Other electronic components may be mounted on the circuit board 25.

The connector 26 penetrates the inside and outside of the case 23 in one side plate portion of the case 23. The terminal 26a of the connector 26 is electrically connected to the circuit pattern 25a of the circuit board 25 in the case 23.

When the connector 26 and the apparatus connector 42 are connected to each other, the circuit pattern 25a of the electric apparatus 22 and the wiring 50 are connected via the terminal 26a and the terminal 42a. In the example illustrated in FIG. 9, a circuit to which the heat conductor 82 is connected in the wire harness 230 is connected to the circuit pattern 25a on which the heat generating component 24 is mounted. As a result, the heat of the heat generating component 24 is easily transferred to the heat conductor 82. The circuit to which the heat conductor 82 is connected in the wire harness 230 may be connected to a circuit pattern different from the circuit pattern 25a on which the heat generating component 24 is mounted.

Here, the heat conductor 82 is a heat drawing wire 82. The heat drawing wire 82 is connected to the terminal 42a. As a result, the thermal conductivity via the heat conductor 82 is enhanced. The heat drawing wire 82 includes a conductor wire 82a and a sheath 82b. For example, one end portion of the conductor wire 82a is connected to the terminal 42a together with the wiring 50. A connection mode of the wiring 50 and the conductor wire 82a with respect to the terminal 42a is not particularly limited, and can be appropriately set. For example, the core wire 53a of the wiring 50 and the conductor wire 82a may be co-crimped to the terminal 42a. For example, the conductor wire 82a and the terminal 42a may be connected by, for example, welding or soldering. The other end portion of the conductor wire 82a is connected to the heat conductive plate 70. The other end portion of conductor wire 82a and the heat conductive plate 70 are connected by, for example, welding, soldering, or the like.

The heat conductor 84 is a filling member 84. The filling member 84 has an insulating property. The filling member 84 fills the space of the cavity 42c on the side from which the wiring 50 is drawn out. Accordingly, the heat conductor 84 connected to the terminal 42a can be easily provided. The filling member 84 is, for example, heat conductive grease. Here, the filling member 84 does not have a portion protruding to the outside of the cavity 42c, and is not connected to the heat conductive plate 70. The filling member 84 is in close contact with the heat drawing wire 82 and the terminal 42a in the cavity 42c to facilitate heat conduction to the heat drawing wire 82. The filling member 84 may have a portion protruding to the outside of the cavity 42c, and the portion protruding to the outside of the cavity 42c may be connected to the heat conductive plate 70. In this case, the heat drawing wire 82 may be omitted.

### <Connection Relationship Example of Wiring>

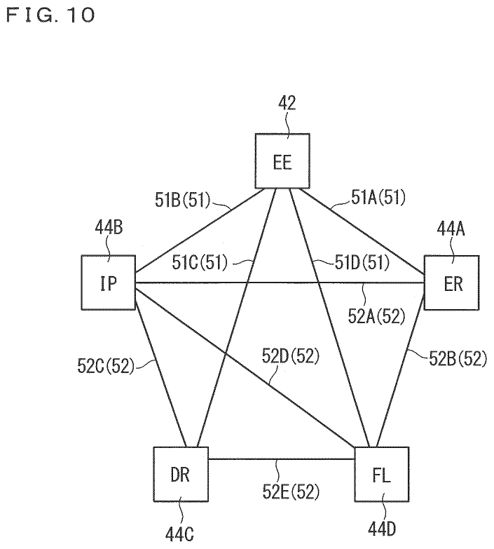

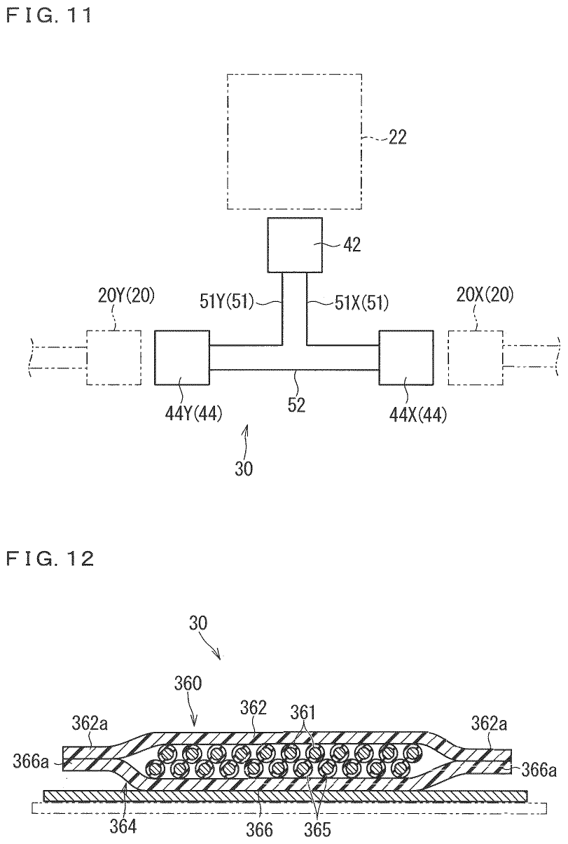

FIG. 10 is a diagram explaining a connection relationship between a plurality of types of connectors 42 and 44 and a plurality of wirings 50. FIG. 11 is a diagram explaining a connection relationship between the apparatus connector 42, a first harness connector 44X, and a second harness connector 44Y.

The wire harness 30 includes the apparatus connector 42 and a plurality of types of harness connectors 44. The apparatus connector 42 is connected to the connector 26 of the electric apparatus 22. Connectors of the counterpart wire harness 20, different from each other, are connected to the plurality of types of harness connectors 44, respectively. Herein, the engine room (ER) harness connector 44A, the instrument panel (IP) harness connector 44B, the door (DR) harness connector 44C, and the floor (FL) harness connector 44D are provided as the plurality of types of harness connectors 44. All of the engine room harness connector 44A, the instrument panel harness connector 44B, the door harness connector 44C, and the floor harness connector 44D need not be provided as the plural types of harness connectors 44, however, it is sufficient that two or more types of harness connectors 44 are provided. When the roof harness 20E is assumed as the counterpart wire harness 20, a roof harness connector 44E is provided as one type of the plurality of types of harness connectors 44. The roof harness connector 44E may be provided on an upper side of the apparatus connector 42, the engine room harness connector 44A, the instrument panel harness connector 44B, the door harness connector 44C, and the floor harness connector 44D in the vehicle, for example. The wiring connected to the roof harness connector 44E may extend in the up-down direction on a lateral side of the apparatus 22.

In the example illustrated in FIG. 6, each type of the connector 40 is one connector. That is to say, each of the apparatus connector 42, the engine room harness connector 44A, the instrument panel harness connector 44B, the door harness connector 44C, and the floor harness connector 44D is one connector. In the present disclosure, two or more connectors are considered one type of connector when the connection destination thereof is the same as each other. In other words, any number of connectors connected to the same apparatus 22 or the same counterpart wire harness 20 are considered as one type of connector. From the other viewpoint, each of the plural types of connectors 40 is made up of one or more connectors (referred to as a split connector hereinafter). Each type of connector may include a connector having the same structure. Herein, the connectors having the same structure are considered different types of connector when the connection destinations thereof are different from each other.

At least one of the plural types of connectors 40 may include two or more split connectors. For example, the connector 40 having a largest number of electrodes (apparatus connector 42, for example) in the plural types of connectors 40 may include two or more split connectors. Accordingly, the connector 40 having the largest number of electrodes in the plural types of connectors 40 can be easily manufactured.

When the connector 40 includes the plurality of split connectors, it is preferable that the plural types of connectors 40 are four or more types of connector, and the number of the split connectors is equal to or smaller than N. Herein, N is a number obtained by subtracting two from the number of types of the plurality of types of connectors 40 in the wire harness 30. Accordingly, the number of groups of connectors to be fitted can be reduced compared with a case where the other type of connector 40 is connected to the connection destination of one type of connector 40. Specifically, the connectors 40 in the wire harness 30 include five types of connectors, that is, the apparatus connector 42, the engine room harness connector 44A, the instrument panel harness connector 44B, the door harness connector 44C, and the floor harness connector 44D. Thus, when each of the apparatus connector 42, the engine room harness connector 44A, the instrument panel harness connector 44B, the door harness connector 44C, and the floor harness connector 44D includes a plurality of split connectors, the number thereof is preferably three or less. For example, when each of four counterpart wire harnesses 20, that is, the engine room harness 20A, the instrument panel harness 20B, the door harness 20C, and the floor harness 20D, is connected to the apparatus 22, four groups of connectors need to be fitted. In contrast, when the apparatus connector 42 is made up of three or less split connectors, the number of groups of the connectors to be fitted can be three or less.

The plurality of wirings 50 include a through circuit wiring 52 and a plurality of apparatus wirings 51. The through circuit wiring 52 connects the harness connectors 44. The apparatus wiring 51 connects the apparatus connector 42 and the harness connector 44.

As illustrated in FIG. 10, apparatus wirings 51A, 51B, 51C, and 51D are provided as the apparatus wiring 51 herein. The apparatus wiring 51A connects the engine room harness connector 44A and the apparatus connector 42. The apparatus wiring 51B connects the instrument panel harness connector 44B and the apparatus connector 42. The apparatus wiring 51C connects the door harness connector 44C and the apparatus connector 42. The apparatus wiring 51D connects the floor harness connector 44D and the apparatus connector 42. The number of each of the apparatus wirings 51A, 51B, 51C, and 51D may be one or more.

As illustrated in FIG. 10, through circuit wirings 52A, 52B, 52C, 52D, and 52E are provided herein as the through circuit wiring 52. The through circuit wiring 52A connects the engine room harness connector 44A and the instrument panel harness connector 44B. The through circuit wiring 52B connects the engine room harness connector 44A and the floor harness connector 44D. The through circuit wiring 52C connects the instrument panel harness connector 44B and the door harness connector 44C. The through circuit wiring 52D connects the instrument panel harness connector 44B and the floor harness connector 44D. The through circuit wiring 52E connects the door harness connector 44C and the floor harness connector 44D. The number of each of the through circuit wirings 52A, 52B, 52C, 52D, and 52E may be one or more.

Accordingly, the wiring 50 is provided to nine routes other than one route between the engine room harness connector 44A and the door harness connector 44C in ten routes of five types of connectors 42 and 44.

As illustrated in FIG. 11, in the present disclosure, the plurality of types of harness connectors 44 include the first harness connector 44X and the second harness connector 44Y. The first harness connector 44X is connected to a first counterpart wire harness 20X. The second harness connector 44Y is connected to a second counterpart wire harness 20Y. Three types of connectors 42 and 44, namely the apparatus connector 42, the first harness connector 44X, and the second harness connector 44Y, are connected to each other by the wirings 50. Specifically, the first harness connector 44X and the second harness connector 44Y are connected to the apparatus connector 42 by the plurality of apparatus wirings 51. The apparatus connector 42 and the first harness connector 44X are connected by a first apparatus wiring 51X. The apparatus connector 42 and the second harness connector 44Y are connected by a second apparatus wiring 51Y. The first harness connector 44X and the second harness connector 44Y are connected by the through circuit wiring 52. Description will be given on whether or not four types of harness connectors 44, namely the engine room harness connector 44A, the instrument panel harness connector 44B, the door harness connector 44C, and the floor harness connector 44D, fall under the first harness connector 44X and the second harness connector 44Y.

Six groups of connectors are generated as a combination made by selecting two of four types of harness connectors 44 of the engine room harness connector 44A, the instrument panel harness connector 44B, the door harness connector 44C, and the floor harness connector 44D. Each of five of six groups except for one group made up of the engine room harness connector 44A and the door harness connector 44C includes the through circuit wiring 52 connecting two types of harness connectors 44 in each of five groups. All of four types of harness connectors 44 of the engine room harness connector 44A, the instrument panel harness connector 44B, the door harness connector 44C, and the floor harness connector 44D are connected to the apparatus connector 42 via the apparatus wiring 51. Thus, five of six groups except for one group made up of the engine room harness connector 44A and the door harness connector 44C can be considered as a combination of the first harness connector 44X and the second harness connector 44Y.

Meanwhile, herein, the wire harness 30 does not include the through circuit wiring 52 connecting the engine room harness connector 44A and the door harness connector 44C. Thus, the engine room harness connector 44A and the door harness connector 44C are not considered as a combination of the first harness connector 44X and the second harness connector 44Y herein.

Three or more types of harness connectors 44 may be provided as the plurality of types of harness connectors 44, and the wire harness 30 may include the through circuit wiring 52 that connects three or more types of harness connectors 44 to each other. Four groups of connectors are generated as a combination made by selecting three of four types of harness connectors 44 of the engine room harness connector 44A, the instrument panel harness connector 44B, the door harness connector 44C, and the floor harness connector 44D. Each of two of four groups except for two groups including the engine room harness connector 44A and the door harness connector 44C together includes the through circuit wiring 52 connecting three types of harness connectors 44 in each of four groups. Each of two of four groups except for two groups including the engine room harness connector 44A and the door harness connector 44C together can be considered the three or more types of harness connectors 44.

Specifically, the engine room harness connector 44A, the instrument panel harness connector 44B, and the floor harness connector 44D are connected to each other via the through circuit wirings 52A, 52B, and 52D. Thus, a combination of the engine room harness connector 44A, the instrument panel harness connector 44B, and the floor harness connector 44D can be considered the three or more types of harness connectors 44. In the similar manner, the instrument panel harness connector 44B, the door harness connector 44C, and the floor harness connector 44D are connected to each other via the through circuit wirings 52C, 52D, and 52E. Thus, a combination of the instrument panel harness connector 44B, the door harness connector 44C, and the floor harness connector 44D can be considered the three or more types of harness connectors 44.

However, the through circuit wiring 52 connecting the engine room harness connector 44A and the door harness connector 44C may be provided in the wire harness 30. In this case, the engine room harness connector 44A, the instrument panel harness connector 44B, the door harness connector 44C, and the floor harness connector 44D are connected to each other via the through circuit wiring 52.

It is also understood that the wiring 50 includes a plurality of wirings 51X and 51Y branched from the apparatus connector 42 and connected to the first harness connector 44X and the second harness connector 44Y.

An arrangement example of the wire harness 30 in the vehicle 10 will be described on the premise of the connection relationship example of the wiring 50.

As illustrated in FIG. 2, here, a part of the wire harness 30 is disposed along the dashboard panel 11. A wiring part extending from the engine room harness connector 44A is held to be disposed along the dashboard panel 11.

Another part of the wire harness 30 is disposed along the cowl side panel 15. The instrument panel harness connector 44B, the door harness connector 44C, and the floor harness connector 44D are held so that they are arranged in a height direction and a wiring part extending from each of the instrument panel harness connector 44B, the door harness connector 44C, and the floor harness connector 44D are disposed along the cowl side panel 15.

The wire harness 30 is disposed in a state of being bent in the thickness direction between a portion disposed along the dashboard panel 11 and a portion disposed along the cowl side panel 15. For example, the protector 54 may be provided to a portion of the wire harness 30 disposed along the cowl side panel 15. The wiring 50 may be bent outside the protector 54. The sheet member 58 may be provided to a portion of the wire harness 30 disposed along the cowl side panel 15 and a portion disposed along the dashboard panel 11. The sheet member 58 may be bent together with the wiring 50 between the portion disposed along the cowl side panel 15 and the portion disposed along the dashboard panel 11.

A length of each of the plurality of wirings 50 is equal to or smaller than one meter. In the wire harness 30, the longest wiring 50 is the through circuit wiring 52B connecting the engine room harness connector 44A and the floor harness connector 44D, or the through circuit wiring 52C connecting the instrument panel harness connector 44B and the floor harness connector 44D. A length of each of these through circuit wirings 52B and 52C is equal or smaller than one meter.

### <Configuration Example for Maintaining Wiring in Flat State>

FIG. 12 illustrates a third modification example of the wiring 50 and the base member 54. As illustrated in the drawing, a plurality of wiring groups 360 and 364 may be stacked to form a wire harness 330. In the example illustrated in FIG. 12, some of the plurality of wirings 50 are collected to constitute the first wiring group 360, and some of the rest of the plurality of wirings 50 are collected separately from the first wiring group 360 to constitute the second wiring group 364. Herein, the plurality of wirings 50 are fixed to the base members 362 and 366 and collected.

Each of the first wiring group 360 and the second wiring group 364 are flatly formed and stacked to each other. Herein, the first wiring group 360 includes a plurality of electrical wires 361 and the flat base member 362 keeping the plurality of electrical wires 361 flat. The electrical wire 361 and the base member 362 are fixed to each other herein. The electrical wire 361 and the base member 362 may not be fixed to each other. The second wiring group 364 includes a plurality of electrical wires 365 and the flat base member 366 keeping the plurality of electrical wires 365 flat. The electrical wire 365 and the base member 366 are fixed to each other herein. The electrical wire 365 and the base member 366 may not be fixed to each other.

The first wiring group 360 and the second wiring group 364 are stacked such that a main surface of the base member 362 to which the electrical wire 361 is fixed and a main surface of the base member 366 to which the electrical wire 365 is fixed face each other. Accordingly, the electrical wires 361 and 365 are surrounded and protected by the base members 362 and 366. However, the first wiring group 360 and the second wiring group 364 may be stacked such that the main surface of the base member 362 to which the electrical wire 361 is fixed and the main surface of the base member 366 to which the electrical wire 365 is not fixed face each other, or may be stacked such that the main surface of the base member 366 to which the electrical wire 365 is fixed and the main surface of the base member 362 to which the electrical wire 361 is not fixed face each other. In addition, the first wiring group 360 and the second wiring group 364 may be stacked such that a main surface of the base member 362 to which the electrical wire 361 is not fixed and a main surface of the base member 366 to which the electrical wire 365 is not fixed face each other.

The first wiring group 360 and the second wiring group 364 are stacked such that the electrical wire 361 and the electrical wire 365 overlap each other. The electrical wires 361 and 365 have two stages in which the one-stage electrical wire 361 and the one-stage electrical wire 365 overlap. Depending on the convenience of the space at the place where the wire harness 30 is disposed, it may be desired that the width dimension of at least a part of the wire harness 30 is reduced even if the thickness dimension is slightly increased. In such a case, for example, the electrical wires 361 and 365 may have three or more stages. Further, for example, the base members 362 and 366 may not be provided, and the electrical wires 361 and 365 may be bundled by a binding member such as a tape so as to have a circular cross section.

The base member 362 includes an extension piece 362a. The extension piece 362a is provided on both sides of a portion where the electrical wire 361 is disposed. The base member 366 also includes a similar extension piece 366a. When the extension piece 362a of the base member 362 and the extension piece 366a of the base member 366 are fixed to each other, the first wiring group 360 and the second wiring group 364 are fixed to each other. However, the extension piece 362a of the base member 362 and the extension piece 366a of the base member 366 need not be fixed to each other.

### <Example of how to Divide a Plurality of Wirings>

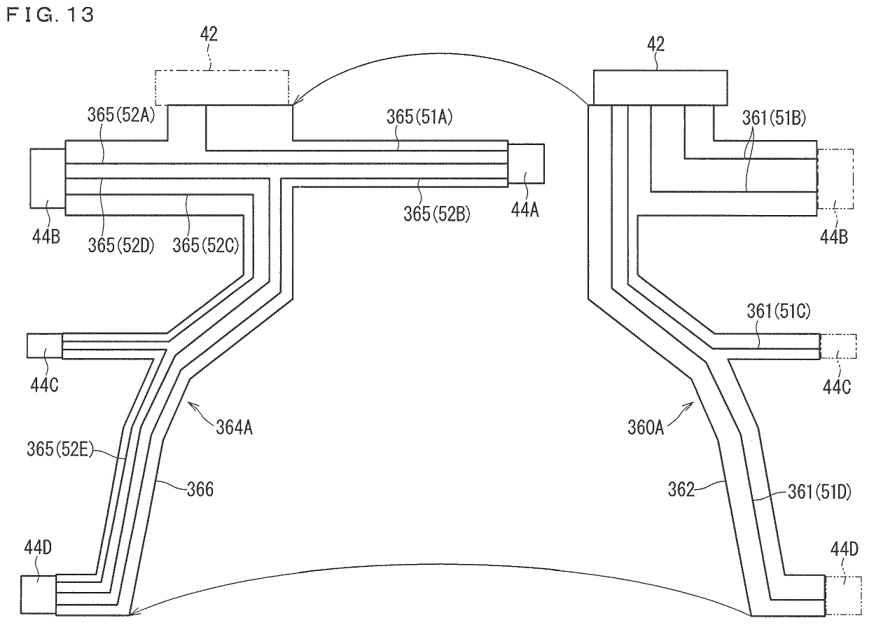

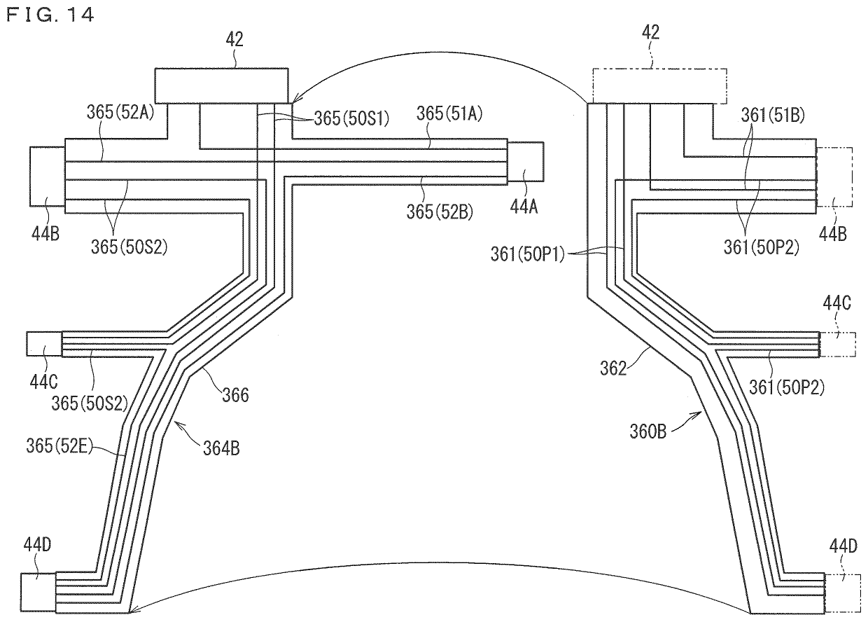

In the case where the first wiring group 360 and the second wiring group 364 are stacked to form the wire harness 330 as in the example illustrated in FIG. 12, a dividing method to sort the plurality of wirings 50 into the first wiring group 360 and the second wiring group 364 is not particularly limited, and can be appropriately set. An example of how to divide the plurality of wirings 50 will be described with reference to FIGS. 13 and 14. FIG. 13 is a diagram illustrating an example of how to divide the plurality of wirings 50. FIG. 14 is another diagram illustrating an example of how to divide the plurality of wirings 50.

In the example illustrated in FIG. 13, the plurality of wirings 50 are sorted on the basis of the apparatus wiring 51 and the through circuit wiring 52. Specifically, more than half of the wirings in the first wiring group 360A are the apparatus wirings 51. More than half of the wirings in the second wiring group 364A are the through circuit wirings 52. In the first wiring group 360A, 60% or more of the wirings may be the apparatus wirings 51, 70% or more may be the apparatus wirings 51, 80% or more may be the apparatus wirings 51, or 90% or more may be the apparatus wirings 51. All (100%) of the wirings in the first wiring group 360A may be the apparatus wirings 51. In the similar manner, in the second wiring group 364A, 60% or more of the wirings may be the through circuit wirings 52, 70% or more may be the through circuit wirings 52, 80% or more may be the through circuit wirings 52, or 90% or more may be the through circuit wirings 52. All (100%) of the wirings in the second wiring group 364 may be the through circuit wirings 52.

In the example illustrated in FIG. 13, all (100%) of the wirings in the first wiring group 360A are the apparatus wirings 51. In addition, 90% or more of the wiring in the second wiring group 364A are the through circuit wirings 52. The apparatus wiring 51A connecting the engine room harness connector 44A and the apparatus connector 42, among the apparatus wirings 51, are included in the second wiring group 364A. The apparatus wirings 51B, 51C, and 51D except for the apparatus wiring 51A, among the apparatus wirings 51, are included in the first wiring group 360A. All of the through circuit wirings 52 are included in the second wiring group 364A.

In the first wiring group 360A, the electrical wires 361 are disposed so as not to intersect with each other on the base member 362. Also in the second wiring group 364A, the electrical wires 365 are disposed so as not to intersect with each other on the base member 366. Accordingly, an increase of the thickness of each of the first wiring group 360 and the second wiring group 364 is suppressed, and an increase of the thickness of the wire harness 30 in which the first wiring group 360 and the second wiring group 364 are stacked to each other is suppressed. However, in at least one of the first wiring group 360 and/or the second wiring group 364, an intersection part where the electrical wires intersect with each other on the base member may also be provided.

In the example illustrated in FIG. 14, the wirings 50 are sorted into a first wiring group 360B and a second wiring group 364B on the basis of whether each wiring is a power source line 50P or a signal line 50S. Specifically, more than half of the wirings in the first wiring group 360B are the power source line 50P, and more than half of the wirings in the second wiring group 364B are the signal line 50S. A ratio of the power source lines 50P in the first wiring group 360B is higher than that of the power source lines in the second wiring group 364B. Accordingly, most of the power source lines 50P and most of the signal lines 50S can be separated.

The ratio of the power source lines 50P in the first wiring group 360B is not particularly limited, but can be appropriately set. For example, the ratio of the power source lines 50P in the first wiring group 360B may be equal to or higher than 50% or lower than 50%. That is to say, more than half of the wirings in first wiring group 360B may be the power source lines 50P or signal lines.

More than half of all the power source lines in the wire harness 330 may be disposed in the first wiring group 360B. More than half of all the signal lines in the wire harness 330 may be disposed in the second wiring group 364B. The first wiring group 360B may or may not include the signal line. The second wiring group 364B may or may not include the power source line.

In the example illustrated in FIG. 14, among the wirings 50 connected to the door harness connector 44C and the wirings 50 connected to the floor harness connector 44D, the power source line 50P is provided to the first wiring group 360B, and the signal line 50S is provided to the second wiring group 364. A power source line 50P1 in the first wiring group 360B connects each of the door harness connector 44C and the floor harness connector 44D to the apparatus connector 42. A power source line 50P2 in the first wiring group 360B connects each of the door harness connector 44C and the floor harness connector 44D to the other harness connector 44. A signal line 50S1 in the second wiring group 364B connects each of the door harness connector 44C and the floor harness connector 44D to the apparatus connector 42. A signal line 50S2 in the second wiring group 364B connects each of the door harness connector 44C and the floor harness connector 44D to the other harness connector 44.

In the wire harness 330, the portion disposed along the dashboard panel 11 is only the second wiring group 364 of the first wiring group 360 and the second wiring group 364. Thus, the wire harness 330 is easily bent in the thickness direction between the portion disposed along the dashboard panel 11 and the portion disposed along the cowl side panel 15.

### <Effect etc.>

According to the wire harness 30 configured as described above, the heat conductors 80 and 82 thermally connecting the circuit and the heat conductive plate 70 are provided, so that the heat generated by the heat generating component 24 is transferred to the heat conductive plate 70 via the circuit and the heat conductors 80 and 82. The heat conductive plate 70 is a plate that extends along the wiring 50. Therefore, the heat from the heat generating component 24 is effectively dissipated by the heat conductive plate 70, and the heat dissipation of the electric apparatus 22 to which the wire harness 30 is connected can be enhanced. Furthermore, the heat generated by the circuit itself of the wire harness 30 due to the current is also transmitted to the heat conductive plate 70 via the heat conductors 80 and 82. Therefore, the temperature rise in the circuit of the wire harness 30 can also be suppressed, and the size of the circuit can be reduced with respect to the current size.

In particular, in recent years, a configuration in which a zone ECU is installed for each zone of a vehicle separately from a central electronic control unit (ECU) has increased. It is desired to downsize at least one of the central ECU and the zone ECU while considering measures against heat. According to the present embodiment, by using the electric apparatus 22 as the zone ECU, it is possible to take measures against heat of the zone ECU, and by taking measures against heat of the zone ECU, it is possible to downsize the zone ECU.

In addition, when the heat conductor 80 is connected to the core wire 53a, thermal conductivity between the wiring 50 and the heat conductor 80 is enhanced. As a result, the temperature rise in the core wire 53a can also be suppressed, and the size of the core wire 53a can be reduced with respect to the current value.

In addition, when the heat conductor 80 is connected to the core wire 53a in the intermediate peeled portion 53c, the sheath 53b can be interposed between the connection position between the core wire 53a and the heat conductor 80, and the electric apparatus 22, and it is easy to ensure necessary insulation.

Moreover, when the heat conductor 80 connects the core wire 53a and the heat conductive plate 70 via the window parts 55e and 58a formed in the base members 54 and 58, the wiring 50 can be protected by the base members 54 and 58 while ensuring the connection between the core wire 53a and the heat conductive plate 70 by the heat conductor 80.

Furthermore, when the lid 56 presses the wiring 50 that is in contact with heat conductor 80 via the window part 55e formed in the main body 55, adhesion between the wiring 50 and the heat conductor 80 is enhanced. This increases the thermal conductivity between the wiring 50 and the heat conductor 80.

In addition, when the base members 54 and 58 keep the plurality of wirings 50 flat, the heat can be effectively dissipated by the heat conductive plate 70 that can be easily set wide.

In addition, since the power source line 50P has a conductor cross-sectional area larger than that of the signal line 50S, the thermal conductivity is also high in many cases. When the heat conductor 80 is connected to the circuit of power source line 50P, heat dissipation of electric apparatus 22 is further enhanced.

In addition, the wire harness 30 includes the apparatus connector 42, and the first harness connector 44X and the second harness connector 44Y to which the connectors of the counterpart wire harnesses 20X and 20Y are connected, respectively, and the wirings 50 includes a plurality of wirings branched from the apparatus connector 42 and connected to the first harness connector 44X and the second harness connector 44Y. Therefore, the connectors 26 may be provided without providing separate connectors for the counterpart wire harnesses 20X and 20Y in the electric apparatus 22. Therefore, the number of connectors of the electric apparatus 22 can be reduced. Here, even if the total number of connector terminals in the electric apparatus is the same, if the number of connectors is larger, there is a possibility that the electric apparatus becomes larger by the installation space of the connector housing. By reducing the number of connectors in the electric apparatus 22, the electric apparatus 22 can be downsized.

Moreover, the wiring 50 includes the through circuit wiring 52 that connects the first harness connector 44X and the second harness connector 44Y. Therefore, the counterpart wire harness 20X connected to the first harness connector 44X and the counterpart wire harness 20Y connected to the second harness connector 44Y are connected via the through circuit wiring 52. Thus, the plurality of types of counterpart wire harnesses can be connected to each other via the wire harness 30, and the connection between the plurality of types of counterpart wire harnesses and the connection between the plurality of types of counterpart wire harnesses and the apparatus are simplified.

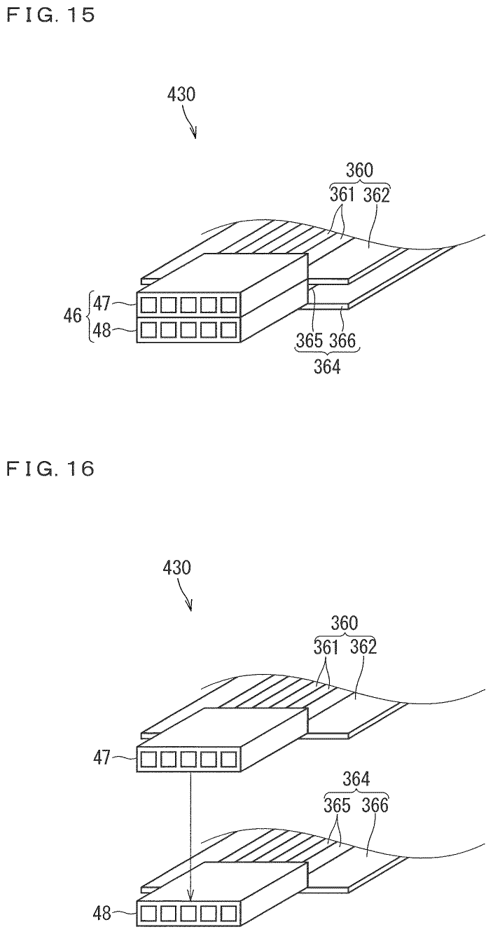

FIG. 15 is a perspective view illustrating a wire harness 430 according to a fourth modification example. FIG. 16 is an exploded perspective view illustrating the wire harness 430 according to the fourth modification example.

In the wire harness 430 according to the fourth modification example, the shape of the connector 46 is different from the shape of the connector 44 in the wire harness 30. Specifically, at least one type in the plurality of types of connectors 44 includes a plurality of split connectors 47 and 48. The plurality of split connectors 47 and 48 include a first split connector 47 and a second split connector 48. The wiring 50 of the first wiring group 360 is connected to the first split connector 47. The wiring of the second wiring group 364 is connected to the second split connector 48. As a result, as compared with the case of the wire harness 30, the work of inserting one of the wiring 50 of the first wiring group 360 and the wiring 50 of the second wiring group 364 into the connector 44 into which one of the wiring 50 of the first wiring group 360 and the wiring 50 of the second wiring group 364 is inserted in advance is less likely to occur. As a result, it is easy to manufacture the first wiring group 360 and the second wiring group 364 separately and then combine them to form the wire harness 430.

Herein, the first split connector 47 and the second split connector 48 are integrated to constitute a stacked connector 46. Accordingly, at least one type of connector 46 in the plural types of connectors 40 is the stacked connector 46 made up of the plurality of split connectors 47 and 48 integrated with each other. Each type of connector 44 may be divided in a form other than the stacked connector 46. For example, the apparatus connector 42 may be divided into a plurality of split connectors arranged in a direction intersecting with the thickness direction. The two split connectors may each be connected to the electric apparatus 22 without being combined.

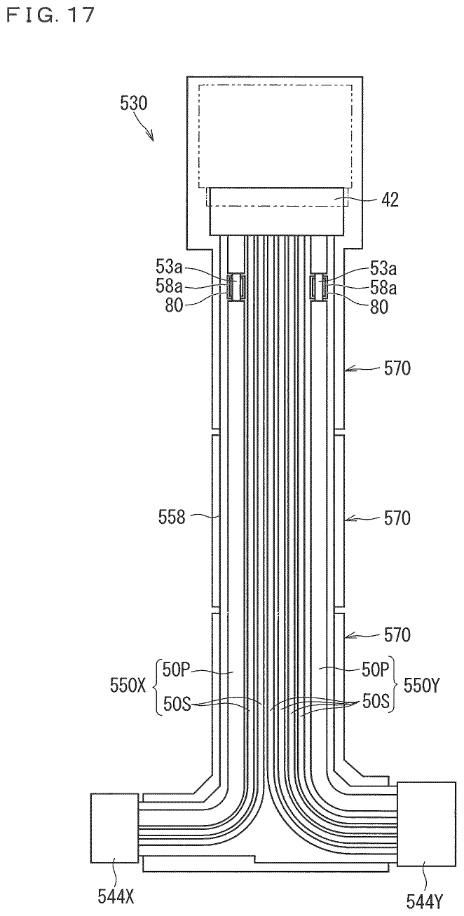

FIG. 17 is a plan view illustrating a wire harness 530 according to a fifth modification example.

In the wire harness 530, the wiring 550 corresponding to the wiring 50 includes a plurality of wirings 550X and 550Y divided from the apparatus connector 42 into a plurality of (here, two) harness connectors 544X and 544Y. The wiring 550 is fixed to a base member 558 such as a sheet member and is maintained in a flat state.

The heat conductive plate 570 corresponding to the heat conductive plate 70 extends along the wiring 550. The heat conductive plate 570 extends, for example, along the base member 558. Similarly to the above embodiment, the heat conductive plate 570 also overlaps the electric apparatus 22. In the present modification, the wire harness 530 does not include the through circuit wiring 52. In addition, the plurality of wirings 50 are not divided into a plurality of groups and are collectively maintained in a flat form.

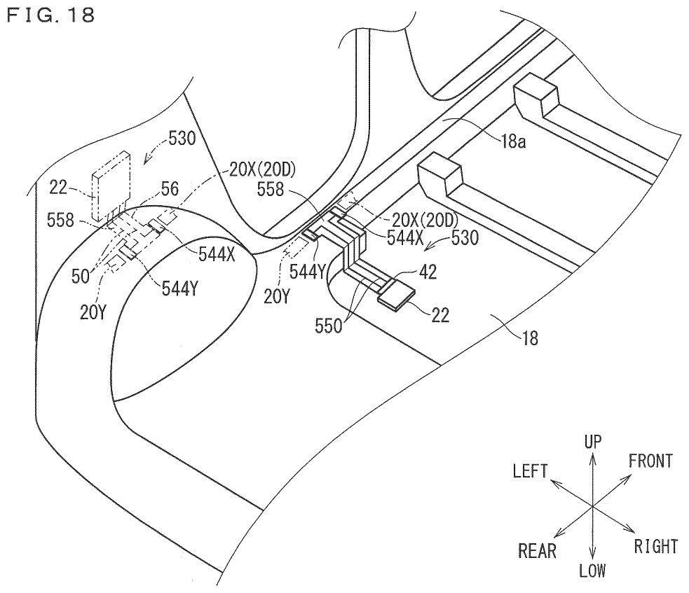

FIG. 18 is a schematic perspective view illustrating an arrangement area of the wire harness 530 according to the fifth modification example. The arrangement area of the wire harness 530 may be an area close to a rear seat or a rear luggage, for example. In this case, a floor harness, a sheet harness, or a rear harness, for example, is assumed as the counterpart wire harness 20. When the wire harness 530 is bent and disposed, the heat conductive plate 570 may be divided into a portion located on one side and a portion located on the other side of the bent portion. As a result, it is easy to bend the wire harness 530 at the bent portion after attaching the heat conductive plate 570.

In addition, the window part 55e of the protector 54 may be formed in the side plate 55b, and the heat conductor 80 may be in contact with the wiring 50 via the window part of the side plate 55b. The window part 55e of the protector 54 may be formed on one of the bottom plate 55a and the lid plate portion 56a that is far from the heat conductive plate 70, and the heat conductor 80 may be in contact with the wiring 50 via the window part. In this case, a part of the heat conductive plate is formed so as to extend to the outside of the side plate 55b, the bottom plate 55a, or the lid plate portion 56a of the protector 54, and the heat conductor 80 is preferably in direct or indirect contact with the extended portion.

Moreover, at least some of the plurality of types of connectors may be standby connectors fixed to the vehicle or the like. For example, at least some of the plural types of harness connectors 44 may be a standby connector. Accordingly, the counterpart wire harness can be easily connected to the harness connector 44.

The configurations described in the embodiments and modification examples thereof can be appropriately combined as long as they are not contradictory.

### EXPLANATION OF REFERENCE SIGNS

10: vehicle
11: dashboard panel
12: body part
13: protrusion part
14, 16: through hole
15: cowl side panel
17: instrument panel reinforcement
18: floor panel
18a: rocker part
19: A pillar
20: counterpart wire harness (20A: engine room harness, 20B: instrument panel harness, 20C: door harness, 20D: floor harness, 20E: roof harness)
20X: first counterpart wire harness
20Y: second counterpart wire harness
22: electric apparatus
23: case
24: heat generating component
25: circuit board
25a: circuit pattern
26: connector
26a: terminal
30, 230, 330, 430, 530: wire harness
42: apparatus connector
42a: terminal
44: harness connector (44A: engine room harness connector, 44B: instrument panel harness connector, 44C: door harness connector, 44D: harness connector, 44E: roof harness connector)
44X, 544X: first harness connector
44Y, 544Y: second harness connector
46: stacked connector
47: first split connector
48: second split connector
50, 550, 550X, 550Y: wiring
50P: power source line
50S: signal line
51, 51A, 51B, 51C, 51D: apparatus wiring
51X: first apparatus wiring
51Y: second apparatus wiring
52, 52A, 52B, 52C, 52D, 52E: through circuit wiring
53, 361, 365: electrical wire
53a: core wire
53b: sheath
53c: intermediate peeled portion
54: protector (base member)
55: main body
55a: bottom plate
55b: side plate
55c: partition plate
55d: groove
55e: window part
55f: fixing piece
55g: hole
56: lid
56a: lid plate portion
56b: side plate portion
58, 362, 366, 558: sheet member (base member)
58a: window part
70, 570: heat conductive plate
70a: hole
71: fixing piece
71a: insertion hole
72: wiring overlapping region
74: apparatus overlapping region
76: binding member
80: heat conductor
82: heat drawing wire (heat conductor)
82a: conductor wire
82b: sheath
84: filling member (heat conductor)
360, 360A, 360B: first wiring group
362a, 366a: extension piece
364, 364A, 364B: second wiring group
S: bolt

1. A wire harness comprising:
a circuit including at least a wiring extending from an electric apparatus that includes a heat generating component;
a heat conductive plate extending along the wiring; and
a heat conductor that thermally connects the circuit and the heat conductive plate.

2. The wire harness according to claim 1, wherein
the wiring includes a core wire and a sheath covering the core wire, and
the heat conductor is connected to the core wire.

3. The wire harness according to claim 2, wherein
an intermediate peeled portion in which the sheath covering the core wire is partially absent is provided in an intermediate portion along an extending direction of the wiring, and
the heat conductor is connected to the core wire in the intermediate peeled portion.

4. The wire harness according to claim 2, further comprising
a base member interposed between the wiring and the heat conductive plate, wherein
the heat conductor connects the core wire and the heat conductive plate via a window part formed in the base member.

5. The wire harness according to claim 4, wherein
the base member is a protector including a main body having a groove in which the wiring is accommodated, and a lid covering the wiring from a side opposite to the main body, and
the window part is formed in a plate portion of one of the main body and the lid, the plate portion being interposed between the wiring and the heat conductive plate, and
an other of the main body and the lid presses the wiring toward the heat conductor.

6. The wire harness according to claim 4, wherein
the base member is a sheet member having flexibility.

7. The wire harness according to claim 4, wherein
the base member keeps a plurality of the wirings flat.

8. The wire harness according to claim 1, wherein
the circuit further includes a terminal connected to an end of the wiring, and
the heat conductor connects the terminal and the heat conductive plate.

9. The wire harness according to claim 8, wherein
the heat conductor includes a heat drawing wire connected to the terminal.

10. The wire harness according to claim 8, wherein
the terminal fits in a cavity of a connector housing,
the heat conductor has an insulating property and includes a filling member filled in the cavity.

11. The wire harness according to claim 1, wherein
a signal line and a power source line having a conductor cross-sectional area larger than a conductor cross-sectional area of the signal line are provided as the wirings, and
the heat conductor is connected to the circuit of the power source line.

12. The wire harness according to claim 1, wherein
an apparatus connector connected to a connector of the electric apparatus, and a first harness connector and a second harness connector to each of which a connector of a counterpart wire harness is connected, are provided, and
the wiring includes a plurality of wirings branched from the apparatus connector and connected to the first harness connector and the second harness connector.

13. The wire harness according to claim 12, wherein
the wiring includes a through circuit wiring connecting the first harness connector and the second harness connector.
